(19) United States
(12) Patent Application Publication
(10) Pub. No.: US 2019/0111918 A1
(43) Pub. Date: Apr. 18, 2019

(54) VEHICLE SYSTEM WITH SAFETY FEATURES

(71) Applicant: Magna Electronics Inc., Auburn Hills, MI (US)

(72) Inventor: Pramod Kumar, Farmington Hills, MI (US)

(21) Appl. No.: 16/155,931

(22) Filed: Oct. 10, 2018

Related U.S. Application Data
(60) Provisional application No. 62/571,947, filed on Oct. 13, 2017.

(51) Int. Cl. B60W 30/09; B60W 10/18; B60W 10/30; H04N 5/247; G06K 9/00

(52) U.S. Cl. CPC B60W 30/09; B60W 10/18; B60W 10/30; H04N 5/247; B60W 2422/00; G06K 9/00785; B60W 2420/42; B60W 2550/308; B60W 2550/302; G06K 9/00805

(57) ABSTRACT

A safety system for a vehicle includes cameras disposed at the driver side door and passenger side door of the vehicle and having respective fields of view exterior the vehicle. A control, responsive to processing at a processor of image data captured by the cameras, determines a potential hazardous condition at the driver side door and/or the passenger side door. The determined potential hazardous condition includes a determination that the driver-side door or the passenger-side door, when opening, will impact an object. Responsive to determination of the potential hazardous condition, the control controls the equipped vehicle to mitigate the potential hazardous condition by limiting opening of the respective driver-side door or the passenger-side door.

### CROSS REFERENCE TO RELATED APPLICATION

The present application claims the filing benefits of U.S. provisional application Ser. No. 62/571,947, filed Oct. 13, 2017, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

The present invention provides a driver assistance system or vision system or imaging system for a vehicle that utilizes one or more cameras (preferably one or more CMOS cameras) to capture image data representative of images exterior of the vehicle, and determines a potential hazardous condition and, responsive to determination of a potential hazardous condition, controls the vehicle to mitigate the potential hazardous condition. For example, the at least one camera may comprise a camera at each door of the vehicle and the determined potential hazardous condition may be determination that the door, when opening, will impact an object, and/or the at least one camera may comprise a plurality of cameras at a parking lot and the determined potential hazardous condition may be determination that another vehicle is approaching an intersection in the parking lot and may collide with the subject vehicle. Optionally, the at least one camera may comprise a plurality of cameras at an intersection and the determined potential hazardous condition is determination that another vehicle is approaching the intersection and may collide with the subject vehicle. Optionally, the at least one camera may comprise a vehicle-based camera disposed at the subject vehicle and the determined potential hazardous condition may be determination that an accident has occurred not involving the subject vehicle, whereby the system may communicate accident information to emergency personnel.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras in accordance with the present invention;

FIG. 2 is a block diagram of an accident determination and reporting system in accordance with the present invention;

FIG. 3 is a block diagram of an intersection safety system in accordance with the present invention;

FIG. 4 is a block diagram of a vehicle door opening safety system in accordance with the present invention; and

FIG. 5 is a block diagram of a parking lot safety system in accordance with the present invention.

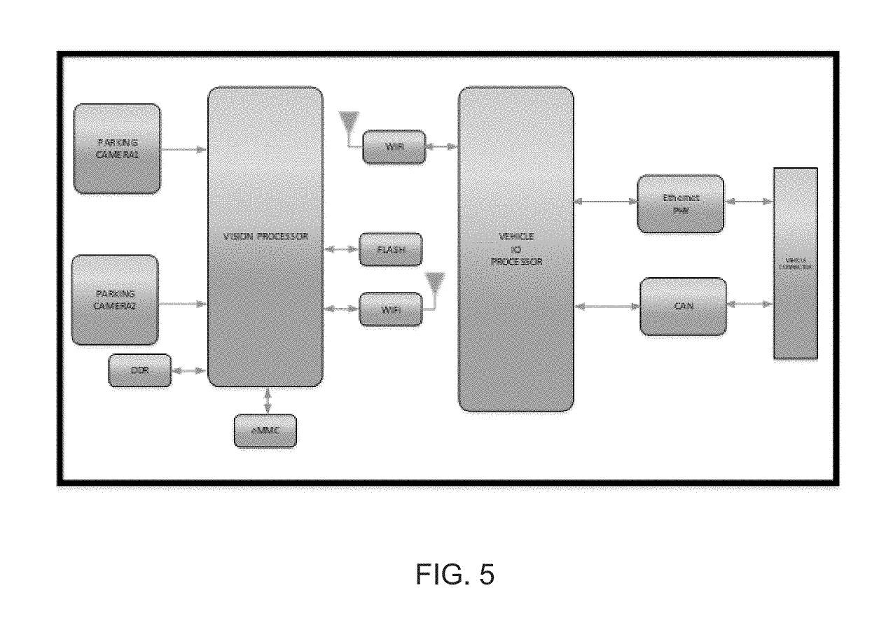

### DESCRIPTION OF THE PREFERRED EMBODIMENTS

A vehicle vision system and/or driver assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide display, such as a rearview display or a top down or bird's eye or surround view display or the like.

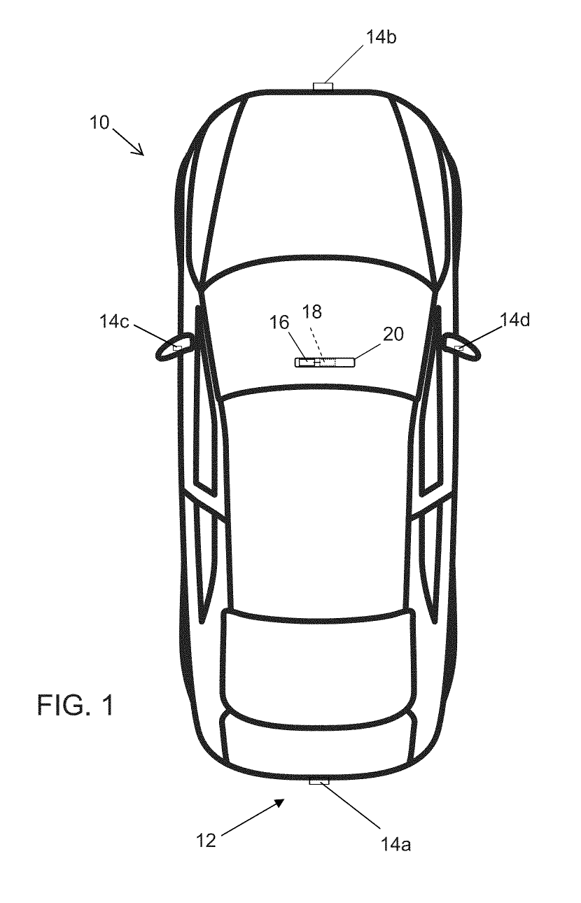

Referring now to the drawings and the illustrative embodiments depicted therein, a vehicle 10 includes an imaging system or vision system 12 that includes at least one exterior viewing imaging sensor or camera, such as a rearward viewing imaging sensor or camera 14a (and the system may optionally include multiple exterior viewing imaging sensors or cameras, such as a forward viewing camera 14b at the front (or at the windshield) of the vehicle, and a sideward/rearward viewing camera 14c, 14d at respective sides of the vehicle), which captures images exterior of the vehicle, with the camera having a lens for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) or processor 18 that is operable to process image data captured by the camera or cameras and may detect objects or the like and/or provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

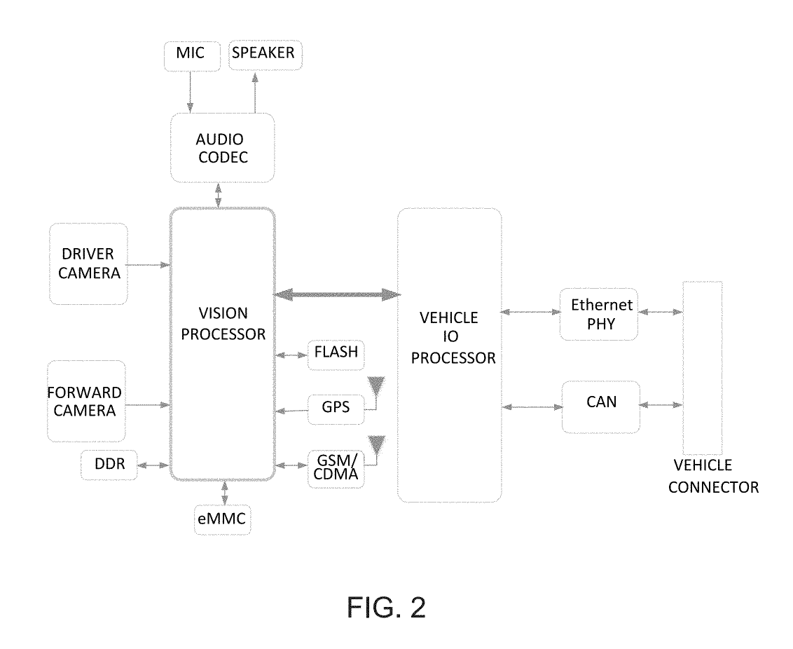

The system of the present invention may provide accident reports over a GPS and GSM (Global System for Mobile Communication)/CDMA (Code Division Multiple Access) network. For example, the control, via processing of image data captured by one of the cameras (such as the forward viewing camera as shown in FIG. 2), can determine an accident and notify the location to a 911 operator and/or to an emergency contact number. The system may use one or more driver or driving assistance system (DAS) camera and GPS and CDMA/GSM technology integration. Also, the front camera and a driver monitor camera may capture video image data or frames of image data and the system may transmit or communicate or send the images or image data to the 911 operator and/or emergency contact number over a communication network (such as a V2X or vehicle-to-infrastructure communication network). This will indicate how critical the accident is and how fast emergency personnel need to arrive at the accident location. Also, the driver can talk over the vehicle telematics system or phone to the emergency contact or 911 operator to discuss the criticality of accident. If the vehicle system determines an accident which is not readily visible (such as along a freeway), the system can help to convey the location to emergency personnel.

The system of the present invention may also provide protection when the vehicle is parked and the door is being opened. Often, a door may be opened and may hit another vehicle parked next to the subject vehicle whereby the other vehicle may get dented or scratched. Also, when opening the vehicle door, the door may hit a person or object next to the parked vehicle. Sometimes, the person opening the door (such as when the vehicle is parked along the side of a road) does not look back and may open the door into the path of oncoming traffic.

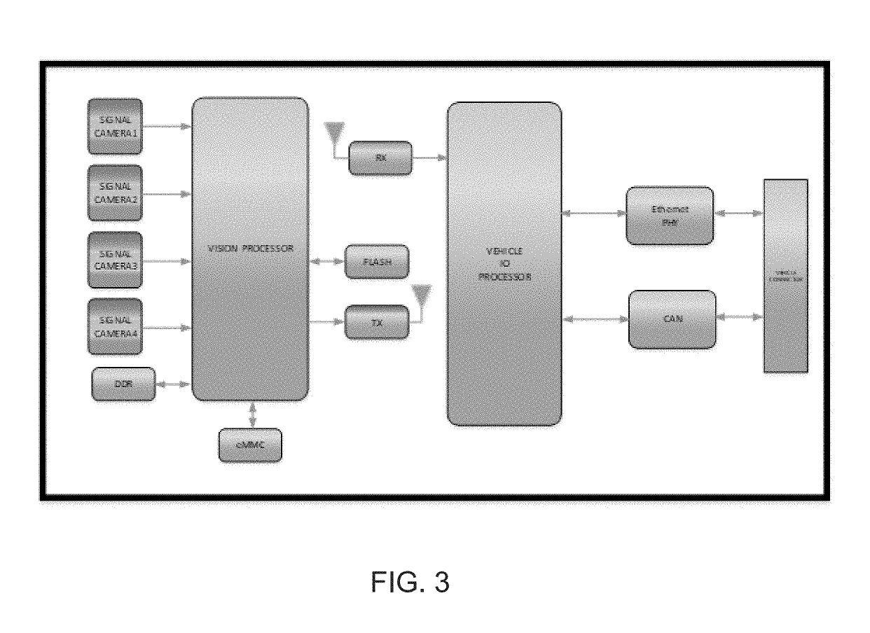

Safety at intersections and traffic signals is very important. Many accidents happen at intersections and traffic signals because of poor decisions and/or poor visibility. The system of the present invention (see FIG. 3) may operate responsive to image data signals received from cameras at the traffic signals. The cameras may be integrated with a vehicle communication interface and may communicate or transmit signals, such as by utilizing aspects of a V2X (vehicle-to-infrastructure) communication system. The camera can communicate information pertaining to a crossing pedestrian, an upcoming vehicle, a not visible vehicle and/or the like. Based on the information communicated to the vehicle, the vehicle control system or the driver of the vehicle can react appropriate. For example, the vehicle control system can stop or slow down the vehicle to allow a crossing vehicle to pass or the system can generate an alert to a driver of the vehicle so the driver can slow down or stop the vehicle or otherwise maneuver the vehicle in accordance with the communicated information.

This feature can be also installed at four way stop sign intersections where the cameras can read and stop a vehicle. The system can communicate signals so as to automatically apply the vehicles' brake systems and to allow the vehicles to proceed through the intersection in an appropriate order (first to stop is the first to go).

All installed cameras can monitor approaching vehicles and give instructions or directions to proceed. The system may also be installed at intersections without traffic signals or stop signs. The camera system may not allow any vehicle to move or proceed until it is safe to proceed through the intersection.

The system may also help for emergency vehicles by allowing emergency vehicles to proceed while stopping other vehicles at the intersection.

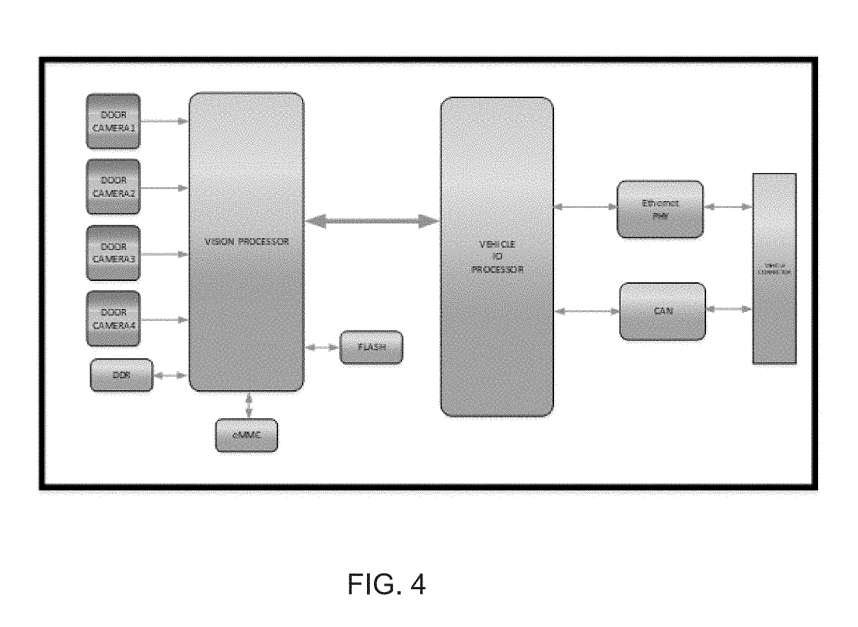

The system of the present invention may include a plurality of door cameras (see FIG. 4) that may be incorporated into the vehicle doors. The cameras and system, responsive to image processing of image data captured by the cameras, can detect how close an object is to an opening door and the system may limit or control the vehicle door to allow the door to open accordingly so as to avoid hitting the other vehicle or object or person by the subject vehicle. Also, the system may function as a security or safety system to identify a person (responsive to image processing of image data captured by the door camera) outside the vehicle and may allow only an identified person to open the vehicle door.

Employee safety in parking areas or lots is very important. The system of the present invention may be operable to provide employee safety in parking area using one or more cameras at the parking area, such as at an office or store or structure at or in or near the parking area. All installed cameras can communicate to the vehicle system over a wireless communication, such as WiFi or the like. Because many office parking areas have their own cameras installed at or in the parking area, crossing area and entry area, the system of the present invention may readily communicate with the existing cameras to determine people or vehicles in the parking area. Many vehicle accidents happen at or in the office parking area, and this can be avoided by integrating office installed cameras with the advance feature of the present invention (such as by using a WiFi network) to communicate information about other vehicles in the parking area.

The system of the present invention, responsive to processing of the signal communicated from one or more parking area cameras, determines that another vehicle is moving in the parking area and may intersect a path of the subject vehicle (and may be a collision hazard). When a determination is made that the two vehicles may collide if they continue on their determined paths, the system of the subject vehicle may control the brake system of the subject vehicle to slow down or stop the subject vehicle to allow the other vehicle to pass ahead of the subject vehicle, or the system may generate an alert to the driver of the subject vehicle so the driver is aware of the other vehicle approaching the path of the subject vehicle and can react accordingly.

Thus, the system of the present invention may communicate with other camera systems (such as camera systems at intersections or camera systems at parking lots or the like) to determine presence of other vehicles, and may control the subject vehicle or generate an alert to the driver of the subject vehicle accordingly. Optionally, the system may utilize cameras of the subject vehicle to determine accidents involving other vehicles and to communicate the location and optionally the severity of the determined accident to emergency personnel. Optionally, the system may utilize cameras at the doors of the subject vehicle to determine when a door may be opened into an object or person or the like, and may control or limit the opening of the vehicle door accordingly.

The cameras or sensors may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in International Publication Nos. WO 2013/081984 and/or WO 2013/081985, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ™ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ladar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. Preferably, the imaging array has at least 300,000 photosensor elements or pixels, more preferably at least 500,000 photosensor elements or pixels and more preferably at least 1 million photosensor elements or pixels. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in International Publication Nos. WO 2010/144900; WO 2013/043661 and/or WO 2013/081985, and/or U.S. Pat. No. 9,126,525, which are hereby incorporated herein by reference in their entireties.

The system may also communicate with other systems, such as via a vehicle-to-vehicle communication system or a vehicle-to-infrastructure communication system or the like. Such car2car or vehicle to vehicle (V2V) and vehicle-to-infrastructure (car2X or V2X or V2I or a 4G or 5G broadband cellular network) technology provides for communication between vehicles and/or infrastructure based on information provided by one or more vehicles and/or information provided by a remote server or the like. Such vehicle communication systems may utilize aspects of the systems described in U.S. Pat. Nos. 6,690,268; 6,693,517 and/or 7,580,795, and/or U.S. Publication Nos. US-2014-0375476; US-2014-0218529; US-2013-0222592; US-2012-0218412; US-2012-0062743; US-2015-0251599; US-2015-0158499; US-2015-0124096; US-2015-0352953; US-2016-0036917 and/or US-2016-0210853, which are hereby incorporated herein by reference in their entireties.

The system may utilize sensors, such as radar or lidar sensors or the like. The sensing system may utilize aspects of the systems described in U.S. Pat. Nos. 9,753,121; 9,689,967; 9,599,702; 9,575,160; 9,146,898; 9,036,026; 8,027,029; 8,013,780; 6,825,455; 7,053,357; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 6,919,549; 6,906,793; 6,876,775; 6,710,770; 6,690,354; 6,678,039; 6,674,895 and/or 6,587,186, and/or International Publication Nos. WO 2018/007995 and/or WO 2011/090484, and/or U.S. Publication Nos. US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

Optionally, the vision system may include a display for displaying images captured by one or more of the imaging sensors for viewing by the driver of the vehicle while the driver is normally operating the vehicle. Optionally, for example, the vision system may include a video display device, such as by utilizing aspects of the video display systems described in U.S. Pat. Nos. 5,530,240; 6,329,925; 7,855,755; 7,626,749; 7,581,859; 7,446,650; 7,338,177; 7,274,501; 7,255,451; 7,195,381; 7,184,190; 5,668,663; 5,724,187; 6,690,268; 7,370,983; 7,329,013; 7,308,341; 7,289,037; 7,249,860; 7,004,593; 4,546,551; 5,699,044; 4,953,305; 5,576,687; 5,632,092; 5,708,410; 5,737,226; 5,802,727; 5,878,370; 6,087,953; 6,173,501; 6,222,460; 6,513,252 and/or 6,642,851, and/or U.S. Publication Nos. US-2014-0022390; US-2012-0162427; US-2006-0050018 and/or US-2006-0061008, which are all hereby incorporated herein by reference in their entireties. Optionally, the vision system (utilizing the forward viewing camera and a rearward viewing camera and other cameras disposed at the vehicle with exterior fields of view) may be part of or may provide a display of a top-down view or bird's-eye view system of the vehicle or a surround view at the vehicle, such as by utilizing aspects of the vision systems described in International Publication Nos. WO 2010/099416; WO 2011/028686; WO 2012/075250; WO 2013/019795; WO 2012/075250; WO 2012/145822; WO 2013/081985; WO 2013/086249 and/or WO 2013/109869, and/or U.S. Publication No. US-2012-0162427, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular safety system, said vehicular safety system comprising:
a driver-side camera disposed at a driver side door of a vehicle equipped with said vehicular safety system and a passenger-side camera disposed at a passenger side door of the equipped vehicle;
wherein said driver-side camera and said passenger-side camera have respective fields of view exterior the equipped vehicle, and wherein said driver-side camera captures image data and said passenger-side camera captures image data;
a control disposed at the equipped vehicle and comprising a processor that processes image data captured by said driver-side camera and image data captured by said passenger-side camera;
wherein said control, responsive to processing at said processor of image data captured by said driver-side camera and image data captured by said passenger-side camera, determines a potential hazardous condition at the driver side door and/or the passenger side door;
wherein the determined potential hazardous condition comprises a determination that the driver-side door or the passenger-side door, when opening, will impact an object detected at the respective driver-side door or the passenger-side door; and
wherein, responsive to determination of the potential hazardous condition, said control controls the equipped vehicle to mitigate the potential hazardous condition by limiting opening of the respective driver-side door or the passenger-side door.

2. The vehicular safety system of claim 1, wherein said control receives image data captured by at least one other camera disposed at the equipped vehicle, and wherein said control, responsive to processing of image data captured by the at least one other camera, determines that an accident not involving the equipped vehicle has occurred within the field of view of the at least one other camera.

3. The vehicular safety system of claim 2, wherein said control communicates information pertaining to the determined accident to emergency personnel.

4. The vehicular safety system of claim 3, wherein the communicated information includes image information derived from image data captured by the at least one other camera disposed at the equipped vehicle.

5. The vehicular safety system of claim 1, wherein said control receives a communication responsive to capture of image data by a plurality of cameras disposed at a parking lot that the equipped vehicle is at, and wherein said control, responsive to the communication, determines if another vehicle is approaching an intersection in the parking lot and may collide with the equipped vehicle.

6. The vehicular safety system of claim 5, wherein, responsive to determination that the other vehicle is approaching the intersection in the parking lot and may collide with the equipped vehicle, said control controls a braking system of the equipped vehicle to slow or stop the equipped vehicle to avoid collision with the other vehicle.

7. The vehicular safety system of claim 1, wherein said control receives a communication responsive to capture of image data by a plurality of cameras disposed at an intersection that the equipped vehicle is approaching, and wherein said control, responsive to the communication, determines if another vehicle is approaching the intersection and may collide with the equipped vehicle.

8. The vehicular safety system of claim 7, wherein the cameras are disposed at traffic signals at the intersection.

9. The vehicular safety system of claim 7, wherein the cameras are disposed at stop signs at the intersection.

10. The vehicular safety system of claim 7, wherein, responsive to determination that the other vehicle is approaching the intersection and may collide with the equipped vehicle, said control generates an alert to the driver of the equipped vehicle.

11. The vehicular safety system of claim 7, wherein, responsive to determination that the other vehicle is approaching the intersection and may collide with the equipped vehicle, said control controls a braking system of the equipped vehicle to slow or stop the equipped vehicle to avoid collision with the other vehicle.

12. A vehicular safety system, said vehicular safety system comprising:
a driver-side camera disposed at a driver side door of a vehicle equipped with said vehicular safety system and a passenger-side camera disposed at a passenger side door of the equipped vehicle;
wherein said driver-side camera and said passenger-side camera have respective fields of view exterior the equipped vehicle, and wherein said driver-side camera captures image data and said passenger-side camera captures image data;
a control disposed at the equipped vehicle and comprising a processor that processes image data captured by said driver-side camera and image data captured by said passenger-side camera;
wherein said control, responsive to processing at said processor of image data captured by said driver-side camera and image data captured by said passenger-side camera, determines a potential hazardous condition at the driver side door and/or the passenger side door;
wherein the determined potential hazardous condition comprises a determination that the driver-side door or the passenger-side door, when opening, will impact an object detected at the respective driver-side door or the passenger-side door;
wherein, responsive to determination of the potential hazardous condition, said control controls the equipped vehicle to mitigate the potential hazardous condition by limiting opening of the respective driver-side door or the passenger-side door; and
wherein said control, responsive to processing of image data captured by said driver-side camera and image data captured by said passenger-side camera, determines that an accident not involving the equipped vehicle has occurred within the field of view of one of said driver-side camera and said passenger-side camera.

13. The vehicular safety system of claim 12, wherein said control communicates information pertaining to the determined accident to emergency personnel.

14. The vehicular safety system of claim 13, wherein the communicated information includes image information derived from image data captured by the one of said driver-side camera and said passenger-side camera.

15. The vehicular safety system of claim 12, wherein said control receives a communication responsive to capture of image data by a plurality of cameras disposed at an intersection that the equipped vehicle is approaching, and wherein said control, responsive to the communication, determines if another vehicle is approaching the intersection and may collide with the equipped vehicle.

16. A vehicular safety system, said vehicular safety system comprising:
a driver-side camera disposed at a driver side door of a vehicle equipped with said vehicular safety system and a passenger-side camera disposed at a passenger side door of the equipped vehicle;
wherein said driver-side camera and said passenger-side camera have respective fields of view exterior the equipped vehicle, and wherein said driver-side camera captures image data and said passenger-side camera captures image data;
a control disposed at the equipped vehicle and comprising a processor that processes image data captured by said driver-side camera and image data captured by said passenger-side camera;
wherein said control, responsive to processing at said processor of image data captured by said driver-side camera and image data captured by said passenger-side camera, determines a potential hazardous condition at the driver side door and/or the passenger side door;
wherein the determined potential hazardous condition comprises a determination that the driver-side door or the passenger-side door, when opening, will impact an object detected at the respective driver-side door or the passenger-side door;
wherein, responsive to determination of the potential hazardous condition, said control controls the equipped vehicle to mitigate the potential hazardous condition by one selected from the group consisting of (i) limiting opening of the respective driver-side door or the passenger-side door and (ii) generating an alert at the respective driver-side door or the passenger-side door;
wherein said control receives a communication responsive to capture of image data by a plurality of cameras disposed at an intersection that the equipped vehicle is approaching, and wherein said control, responsive to the communication, determines if another vehicle is approaching the intersection and may collide with the equipped vehicle;
wherein the intersection comprises an intersection selected from the group consisting of (i) an intersection in a parking lot that the equipped vehicle is at and (ii) an intersection of two roads, one of which the equipped vehicle is traveling along; and
wherein, responsive to determination that the other vehicle is approaching the intersection and may collide with the equipped vehicle, said control (i) generates an alert to the driver of the equipped vehicle and/or (ii) controls a braking system of the equipped vehicle to slow or stop the equipped vehicle to avoid collision with the other vehicle.

17. The vehicular safety system of claim 16, wherein said control receives image data captured by at least one other camera disposed at the equipped vehicle, and wherein said control, responsive to processing of image data captured by the at least one other camera, determines that an accident not involving the equipped vehicle has occurred within the field of view of the at least one other camera.

18. The vehicular safety system of claim 17, wherein said control communicates information pertaining to the determined accident to emergency personnel, and wherein the communicated information includes image information derived from image data captured by the at least one other camera disposed at the equipped vehicle.

19. The vehicular safety system of claim 16, wherein, responsive to determination that the other vehicle is approaching the intersection and may collide with the equipped vehicle, said control generates an alert to the driver of the equipped vehicle.

20. The vehicular safety system of claim 16, wherein, responsive to determination that the other vehicle is approaching the intersection and may collide with the equipped vehicle, said control controls a braking system of the equipped vehicle to slow or stop the equipped vehicle to avoid collision with the other vehicle.
